(19) United States
(12) Patent Application Publication
(10) Pub. No.: US 2006/0136490 A1
(43) Pub. Date: Jun. 22, 2006

(54) Autonomic creation of shared workflow components in a provisioning management system using multi-level resource pools

(75) Inventors: Vijay Kumar Aggarwal, Austin, TX (US); Craig Lawton, Raleigh, NC (US); Christopher Andrew Peters, Pflugerville, TX (US); P.G. Ramachandran, Austin, TX (US); Lorin Evan Ullmann, Austin, TX (US); John Patrick Whitfield, Cary, NC (US)

Correspondence Address: Robert H. Frantz, P.O. Box 23324, Oklahoma City, OK, 73123, US

(73) Assignee: International Business Machines Corporation, Armonk, NY (US)

(21) Appl. No.: 11/016,210

(22) Filed: Dec. 17, 2004

(51) Int. Cl. G06F 7/00

(52) U.S. Cl. 707/103 R

(57) ABSTRACT

Workflows for execution by an autonomic provision management system to yield near clones and replacement systems for a set of targeted computing solutions are provided by determining a common denominator set of workflow steps among the workflows for the targeted computing systems, including workflows to morph a near clone to a specific targeted solution when executed a provisioning management system. Common portions of workflows are identified and archived as workflow templates for re-use in development of new workflows, thus virtualizing the process of subsequent workflow design which use the templates. Multi-level criteria-based searching is provided to workflow designers for finding and re-using existing workflows and workflow templates according to degree of matching common steps, quickest implementation, highest available, or other criteria.

### MICROFICHE APPENDIX

Not applicable.

### INCORPORATION BY REFERENCE

U.S. patent application Ser. No. 10/926,585, filed on Aug. 16, 2004, docket number AUS920040426US1, is incorporated by reference into the present disclosure.

### BACKGROUND OF THE INVENTION

1. Field of the Invention

This invention relates to automatic creation of common componentry workflow in provisioning of multiple solutions in a multi-layer shared server pool.

2. Background of the Invention

As business demands increase for enterprise computing, the need to be able to dynamically configure, or “provision”, new computing solutions rapidly and efficiently becomes crucial. To maximize return on investment in enterprise computing resources, it is often desirable to “unprovision” resources as they are no longer needed in computing resources in order to allow the same resources to be used in new configurations and new solutions. As such, it can be very difficult to effectively manage the ever-fluctuating resources available, while maximizing the resource utilization.

In fact, Information Technology (“IT”) costs can become very expensive when maintaining sufficient resources to meet peak requirements. Furthermore, user inputs are generally required to facilitate such provisioning processes, which incurs additional costs in both time and human resource demand.

To address these needs, many large vendors of enterprise computing systems, such as International Business Machines (“IBM”), Hewlett-Packard (“HP”), Microsoft Corporation, and Sun Microsystems (“Sun”), have begun to develop and deploy infrastructure technologies which are self-managing and self-healing. HP's self-managed computing architecture is referred to as “Utility Computing” or “Utility Data Center”, while Sun has dubbed their initiative “N1”. IBM has applied terms such as “Autonomic Computing”, “Grid Computing”, and “On-Demand Computing” to their various architecture and research projects in this area. While each vendor has announced differences in their approaches and architectures, each shares the goal of providing large-scale computing systems which self-manage and self-heal to one degree or another.

For example, IBM's Autonomic Computing is a self-managing computing model which is patterned on the human body's autonomic nervous system, controlling a computing environment's application programs and platforms without user input, similar to the way a human's autonomic nervous system regulates certain body functions without conscious decisions.

Additionally, IBM has defined their On-Demand Computing technology as an enterprise whose business processes, integrated end-to-end across the company and with key partners, suppliers, and customers, can respond quickly to any customer demand, market opportunity, or external threat.

“Provisioning” is a term used to describe various aspects of managing computing environments, and which often implies different things to different parties. Throughout the present disclosure, we will use the term “provision” or “provisioning” to refer to a sequence of activities that need to happen in a specific order in order to realize a computing environment to meet specific needs and requirements. The activities have dependencies on previous activities, and typically include:
(a) selecting appropriately capable hardware for the requirements, including processor speed, memory, disk storage, etc.;
(b) installing operating system(s);
(c) remotely booting networks;
(d) configuring networks such as Virtual Private Networks (“VPN”) and storage environments like Storage Area Network (“SAN”) or Network Attached Storage (“NAS”); and
(e) deprovisioning resources that are no longer needed back into an available pool.

“Disaster Recovery” is a broad term used in information technology to refer to the actions required to bring computing resources back online after a failure of the existing system, be it a small failure such as the failure of a single heavily loaded server among many servers, or a large failure such as loss of power or communications to an entire computing center. These types of disasters may be caused by failure rates of the components (e.g. hardware and software failures), as well as by non-computing factors such as natural disasters (e.g. tornados, hurricanes, earthquakes, floods, etc.) and other technical disasters (e.g. power outages, virus attacks, etc.).

To recover from a disaster, and computing center must re-provision new servers and systems to replace the processing which was being performed by the previous system(s). Often times, the recovery is performed in a different geographic area, but sometimes the recovery is performed in the same physical or geographic location, depending on the nature of the disaster or failure.

Many businesses which employ or rely upon enterprise computing, create disaster recovery plans to be better prepared when the occasion arise. However, current technology only allows for dedicated servers to be implemented. Each server is typically committed to one purpose or application (e.g. a “solution”), whether it is to meet a new customer requirement (e.g. a “production system”), or to be solely used as a backup server for an existing server that may crash in the near future. When these dedicated servers are not in use, the overall IT maintenance costs increase while excess resources remain idle and unused. It is important to note that in order to save critical time during recovery, when a server is configured as a backup of a production server, the backup server's configuration is usually matched to the production server's configuration so that there is no provisioning time required to bring the backup server online and operational.

Disaster recovery implementation remains challenging even though provisioning with orchestration enables new approaches that are not dependent on high availability operating environments such as IBM's z/OS mainframe operating system, clusters, and addresses. When a disaster occurs, the server will either be reinstalled or once it reaches the end of its usefulness, it will be replaced by a newer version with more features and higher reliability.

During recovery and the process of bringing on line a backup server, often network issues arise, such as Internet Protocol (“IP”) address conflicts, during a period when a degraded or partially operating production server and a newly started backup server operate at the same time.

Further, moving either static configuration data or dynamic state data from a failed or degraded production server to the backup server remains a complicated and difficult procedure, as well.

As a result, once a production server has been deployed in a production environment, it usually is used until a disaster happens, which repeats the provisioning process again while its old implementation problems remains unresolved. These data centers usually require a long time to modify their environments, so most provision for the worst-case scenario, often configuring more hardware than is needed just in case a peak requirement is experienced or a failure is experienced. As a result, most actual hardware and software resources are under-used, increasing the costs of the system considerably. Furthermore, the issue of surges beyond what has been provisioned remains unaddressed (e.g. peak demands above the anticipated peak load).

Provisioning is typically a time and labor consuming process consisting of hundreds of distinct and complex steps, and requiring highly skilled system and network administrators. For example, server provisioning is the process of taking a server from “bare metal” to the state of running live business transactions. During this provisioning process, many problems may arise such as increases in resource expense and declines in level of performance, which in turn can lead to dissatisfied customers and unavailability in services.

Because these are predictable issues, automation can be employed to manage these problems. One objective of the various self-managed computing systems being offered by the major vendor is to automate to an extent as great as possible these provisioning activities, and especially to allow for near real-time reactions to changes in system requirements and demands, with little or no human administrator intervention.

For example, IBM's Tivoli [TM] Provisioning Manager (“TPM”) Rapid Provisioning employs a modular and flexible set of “workflows” for the IBM Tivoli Intelligent Orchestrator product. The workflows have been generalized and packaged for customization by customers seeking to accelerate their provisioning processes. Predefined workflows can be used as a starting point for an organization in automating not only their server provisioning processes, but also other IT processes.

Other products currently offered by the major vendors include HP's OpenView OS Manager using Radia which is a policy-based provisioning and ongoing automated management tool for a variety of operating systems, and Sun's Ni Grid Service Provisioning System, which automates to some degree the provisioning of applications.

Traditionally, customers in the provisioning operating environment have used a dedicated server pool for each solution defined in an organization. In order to satisfy peak demands, servers are committed to this solution to be added when necessary. Thus, extra server capacity is provided when necessary. There has been little to no sharing of these extra resources across solution server pools even though the likelihood of all solutions experiencing their peak demand at the same time is very small.

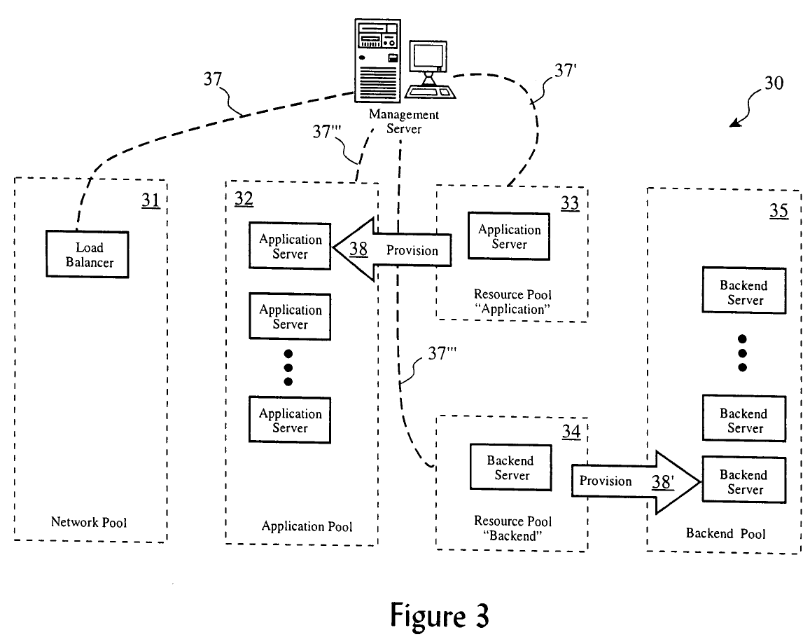

Turning to FIG. 3, a logical view of how one available provisioning manager manages an application cluster (30). The management server (36) gathers the information on resources and then the management services (37, 37′, 37′″) monitor any processes currently being performed or executed. The network pool (31) includes components such as routers, switches, fabrics and load balancers for the network environment. The application pool (32) typically includes a first tier of the applications operating on the servers, such as databases (e.g. IBM DB2, Oracle, etc.), running on top of server platform for suite (e.g. IBM WebSphere or equivalent).

The application resource pool (33) is a group of available, unassigned, unprovisioned servers that can be provisioned (38) into the active application pool. The back-end resource pool (34) contains any backup servers necessary for the application pool (32), such as another set of database servers or web server. The backend pool (35) serves as the collection or group of available servers that have been provisioned (38′) from the back-end resource pool (34).

As such, during disaster recovery, the aforementioned tedious and laborious provisioning activities may have to be performed to realize many servers and many configures, selected from several pools, in order to restore an enterprise.

At least one known modem provisioning management system utilizes “workflows” which defines the provisioning steps for a server. Workflows defined for one solution or server combinations are not reused by another server type or another solution. The servers are imaged and then configured to automatically create a solution. The provisioning of the solution is fully automated using a server in its dedicated single server pool associated with the solution.

However, even with this more advanced provisioning management system, there is provided no ability to create partial solution definitions that can be provisioned to a specific solution server. In addition, the overall number of steps required may not be fully minimized since it is not reused, and all solution needs may not be balanced equally, because optimization for one solution's server pool is likely to be achieved at the expense of another solution.

Therefore, there exists a need in the art for a system and method to determine common componentry across various solutions, and to utilize existing workflows where available and to define new workflows in order to realize these partial solutions. Optimally, any such new system and method would employ virtualization to achieve efficiency across all solution and server combinations.

### DETAILED DESCRIPTION OF THE DRAWINGS

The following detailed description when taken in conjunction with the figures presented herein present a complete description of the present invention.

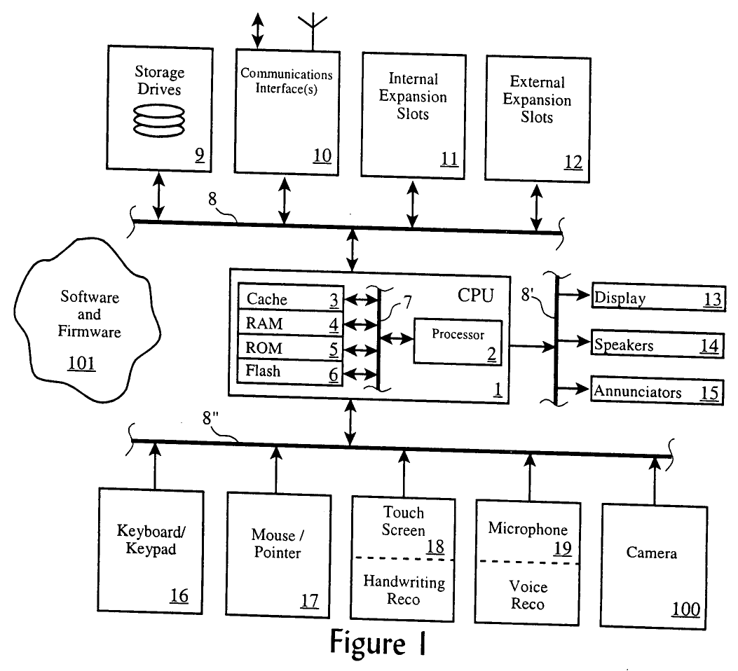

FIG. 1 depicts a generalized computing platform architecture, suitable for realization of the invention.

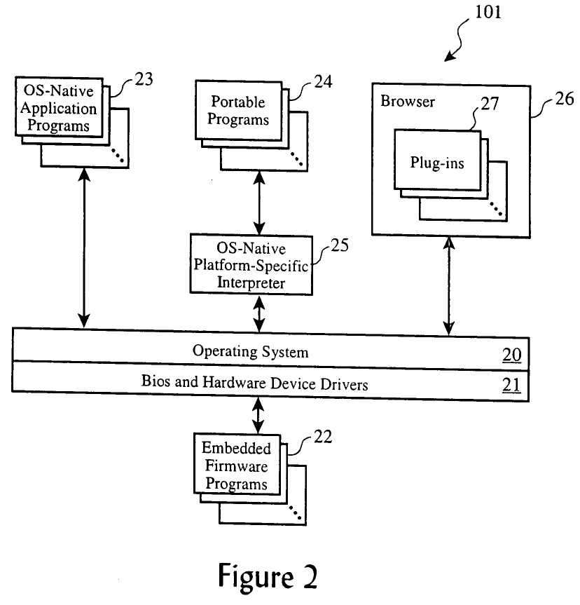

FIG. 2 shows a generalized organization of software and firmware associated with the generalized architecture of FIG. 1.

FIG. 3 illustrates components and activities of typical provisioning management systems suitable for cooperation with the present invention.

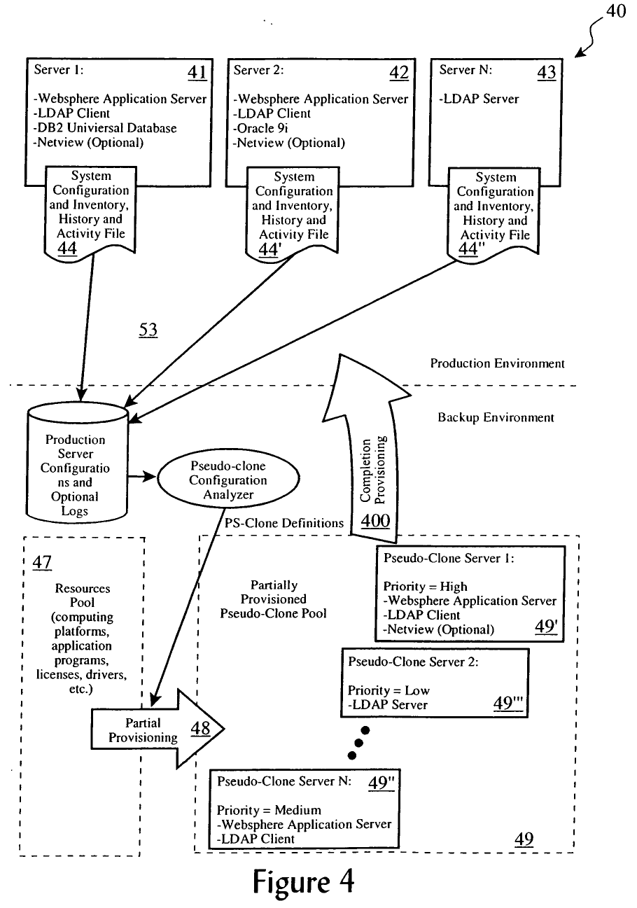

FIG. 4 illustrates components and activities of the pseudo-clone configuration and deployment processes.

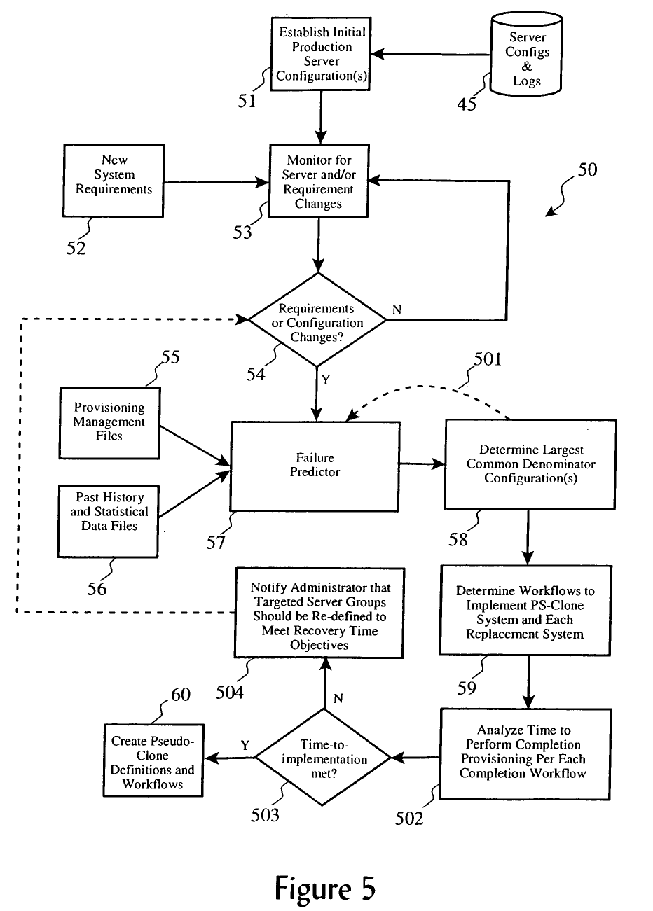

FIG. 5 sets forth a logical process of establishing pseudo-clone systems and performing completion provisioning to yield specific solutions.

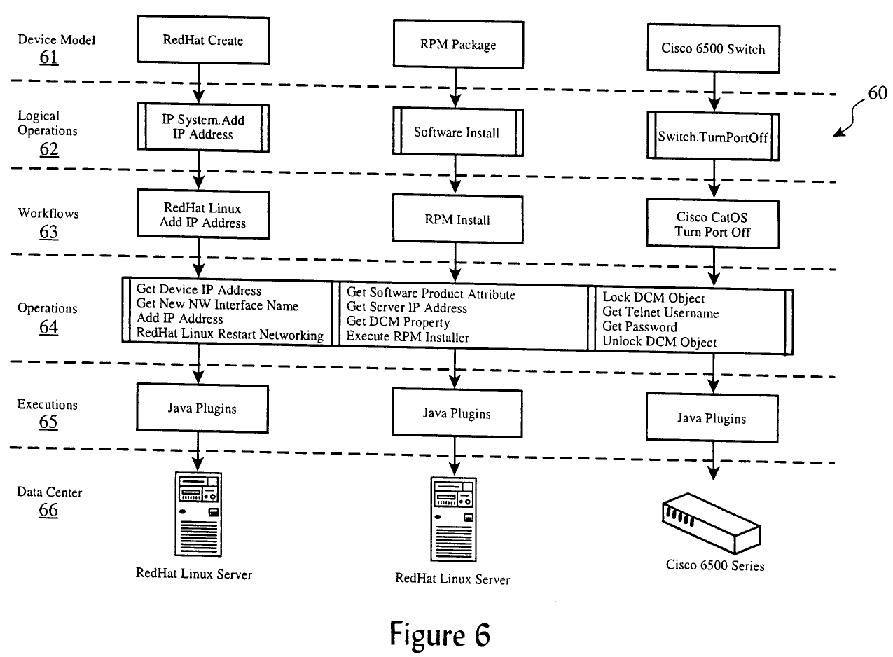

FIG. 6 shows a multi-level model of provisioning activities.

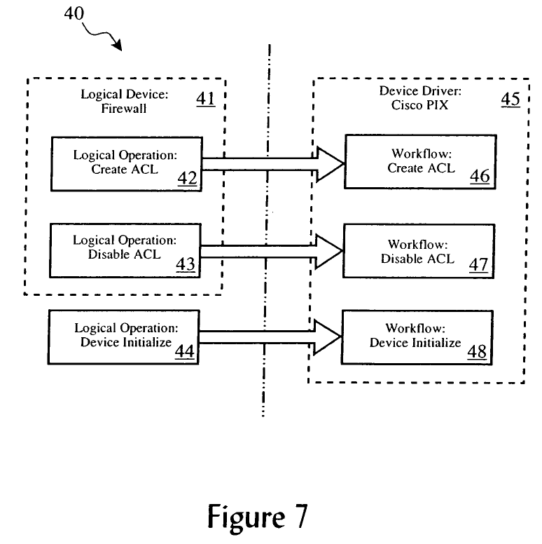

FIG. 7 provides more details of provisioning of a specific networking device to meet a logical operation requirement, e.g. a firewall in this example.

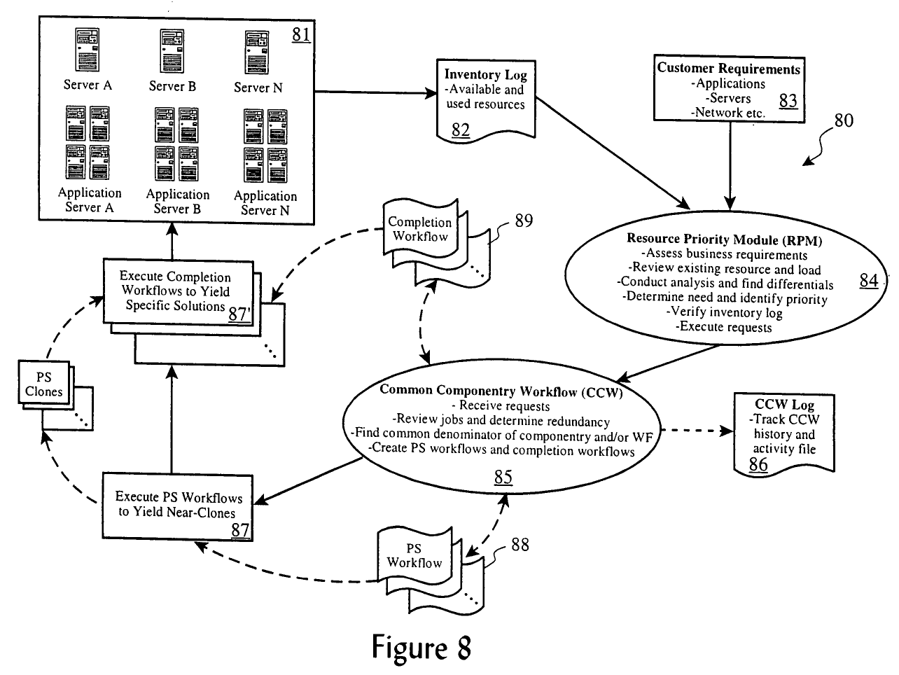

FIG. 8 sets forth a system-level view of the present invention and the arrangement of functional modules according to one embodiment of the present invention.

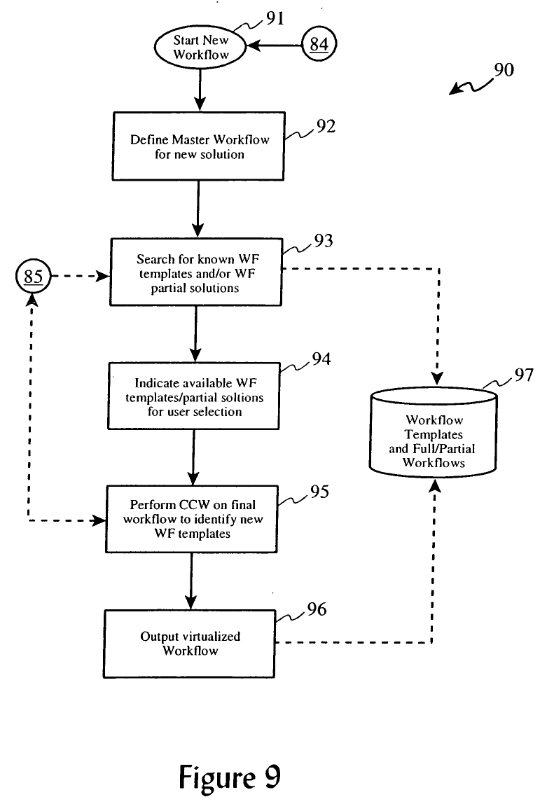

FIG. 9 illustrates a logical process according to the invention for identifying and re-using workflow templates.

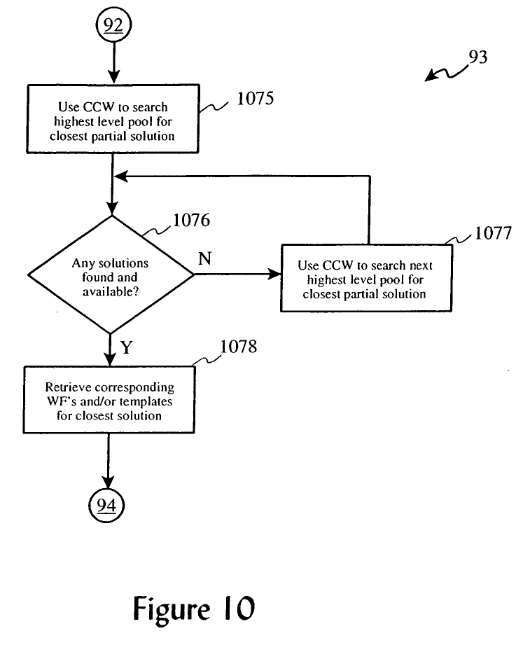

FIG. 10 illustrates multi-level server pool workflow logical processes which identify, in a priority level order, workflows and portions of workflows to adapt partial solutions to replacement solutions.

### SUMMARY OF THE INVENTION

Workflows for execution by an autonomic provision management system to yield near clones and replacement systems for a set of targeted computing solutions are generated by determining a common denominator set of workflow steps among the workflows for other computing systems, including workflows to morph a near clone system to a specific targeted solution when executed a provisioning management system. Common portions of workflows are identified and archived as workflow templates for re-use in development of new workflows, thus virtualizing the process of subsequent workflow design which use the templates. Multi-level criteria-based searching is provided to workflow designers for finding and re-using existing workflows and workflow templates according to degree of matching common steps, quickest implementation, highest available, or other criteria.

### DETAILED DESCRIPTION OF THE INVENTION

Whereas the present disclosure utilizes certain IBM and non-IBM products for illustration of available embodiments, it will be appreciated by those skilled in the art that the present invention is not limited to such realizations, and that the invention can equally well be realized in conjunction with a wide array of other products and services.

General Computing Platform Suitable for Realization of the Invention

The invention is preferably realized as a feature or addition to the software already found present on well-known provisioning management systems. Such computing platforms include enterprise-class severs, to personal computers, as well as smaller and/or portable computing devices, including a suitable provisioning management server software product such as those already discussed. Therefore, it is useful to review a generalized architecture of a computing platform which may span the range of implementation, from a high-end web or enterprise server platform, to a personal computer, to a portable PDA or web-enabled wireless phone.

Turning to FIG. 1, a generalized architecture is presented including a central processing unit (1) (“CPU”), which is typically comprised of a microprocessor (2) associated with random access memory (“RAM”) (4) and read-only memory (“ROM”) (5). Often, the CPU (1) is also provided with cache memory (3) and programmable FlashROM (6). The interface (7) between the microprocessor (2) and the various types of CPU memory is often referred to as a “local bus”, but also may be a more generic or industry standard bus.

Many computing platforms are also provided with one or more storage drives (9), such as a hard-disk drives (“HDD”), floppy disk drives, compact disc drives (CD, CD-R, CD-RW, DVD, DVD-R, etc.), and proprietary disk and tape drives (e.g., Iomega Zip [TM] and Jaz [TM], Addonics SuperDisk [TM], etc.). Additionally, some storage drives may be accessible over a computer network.

Many computing platforms are provided with one or more communication interfaces (10), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (IrDA) interface, too.

Computing platforms are often equipped with one or more internal expansion slots (11), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (12) allowing the user the ability to easily install and remove hardware expansion devices, such as PCMCIA cards, SmartMedia cards, and various proprietary modules such as removable hard drives, CD drives, and floppy drives.

Often, the storage drives (9), communication interfaces (10), internal expansion slots (11) and external expansion slots (12) are interconnected with the CPU (1) via a standard or industry open bus architecture (8), such as ISA, EISA, or PCI. In many cases, the bus (8) may be of a proprietary design.

A computing platform is usually provided with one or more user input devices, such as a keyboard or a keypad (16), and mouse or pointer device (17), and/or a touch-screen display (18). In the case of a personal computer, a full size keyboard is often provided along with a mouse or pointer device, such as a track ball or TrackPoint [TM]. In the case of a web-enabled wireless telephone, a simple keypad may be provided with one or more function-specific keys. In the case of a PDA, a touch-screen (18) is usually provided, often with handwriting recognition capabilities.

Additionally, a microphone (19), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (100), such as a still digital camera or full motion video digital camera.

One or more user output devices, such as a display (13), are also provided with most computing platforms. The display (13) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (14) and/or annunciators (15) are often associated with computing platforms, too. The speakers (14) may be used to reproduce audio and music, such as the speaker of a wireless telephone or the speakers of a personal computer. Annunciators (15) may take the form of simple beep emitters or buzzers, commonly found on certain devices such as PDAs and PIMs.

These user input and output devices may be directly interconnected (8′, 8″) to the CPU (1) via a proprietary bus structure and/or interfaces, or they may be interconnected through one or more industry open buses such as ISA, EISA, PCI, etc. The computing platform is also provided with one or more software and firmware (101) programs to implement the desired functionality of the computing platforms.

Turning to now FIG. 2, more detail is given of a generalized organization of software and firmware (101) on this range of computing platforms. One or more operating system (“OS”) native application programs (23) may be provided on the computing platform, such as word processors, spreadsheets, contact management utilities, address book, calendar, email client, presentation, financial and bookkeeping programs.

Additionally, one or more “portable” or device-independent programs (24) may be provided, which must be interpreted by an OS-native platform-specific interpreter (25), such as Java [TM] scripts and programs.

Often, computing platforms are also provided with a form of web browser or micro-browser (26), which may also include one or more extensions to the browser such as browser plug-ins (27).

The computing device is often provided with an operating system (20), such as Microsoft Windows [TM], UNIX, IBM OS/2 [TM], LINUX, MAC OS [TM] or other platform specific operating systems. Smaller devices such as PDA's and wireless telephones may be equipped with other forms of operating systems such as real-time operating systems (“RTOS”) or Palm Computing's PalmOS [TM].

A set of basic input and output functions (“BIOS”) and hardware device drivers (21) are often provided to allow the operating system (20) and programs to interface to and control the specific hardware functions provided with the computing platform.

Additionally, one or more embedded firmware programs (22) are commonly provided with many computing platforms, which are executed by onboard or “embedded” microprocessors as part of the peripheral device, such as a micro controller or a hard drive, a communication processor, network interface card, or sound or graphics card.

As such, FIGS. 1 and 2 describe in a general sense the various hardware components, software and firmware programs of a wide variety of computing platforms. It will be readily recognized by those skilled in the art that the following methods and processes may be alternatively realized as hardware functions, in part or in whole, without departing from the spirit and scope of the invention.

Provisioning Management Workflows

Because the tasks of provisioning can be very tedious and cumbersome, the role of workflows become vital in the successful completion. A workflow provides the automation capability, the consistent behavior in best practices, and the steps necessary to modify both real world data center and the data center model. It can use Simple Network Management Protocol (“SNMP”), Secure Socket Shell (“SSH”), Telnet, and other protocols to manage servers in the data center. Once written, a workflow such as “install IBM HTTP” server on Windows,” can be replicated throughout the data center with a few clicks of the mouse or triggered automatically by an event.

Application clusters now use workflows to add servers to the cluster and remove them using the most recent versions of these provisioning products. These workflows may add software to a server joining the cluster, changing its hostname, or add an IP address. Resource pools can use workflows to initialize servers in the pool. If a server has an unknown state, the initializing workflow can perform a bare metal install of the operating system and perform whatever configuration is necessary to get the server into a known state and make it available to application clusters. Logical devices have associated logical operations, and workflows can be written to automate these logical operations.

Turning to FIG. 6, component relationships in a multi-layer data center model (60) are shown. This highlights how a generic logical operation can be executed on a specific device. A device model (61) allows the creation of a reusable library of automation processes such as initialize, power on, and power off processes. The device model may not implement all the logical operations, but it can include additional workflows and implement logical operations from other devices. In other words, device models are essentially “packaging” for related workflows which implement the behavior of the device.

Logical operations (62) are groupings of actions such as “software install” or “create route” that may be performed against a physical device such as a switch or router within the data center. Workflows (63) are behaviors expressed in a script-like language, and are part of automation packages. Scripts can be imported or exported, may be written in a nested structure, can pass parameters and their values to subsequent workflows, and can be launched by means such as Simple Object Access Protocol (“SOAP”) interface. A workflow specifies steps to perform the operations (64) that need to be executed (65) in order to create the desired specified data center solution (66). In this illustration, three examples are given: (a) for a RedHat [TM]-based server, (b) for a RedHat Package Manager (“RPM”) solution, and for a Cisco [TM] switch solution, all of which are needed for the hypothetical data center (66) in this example.

According to one embodiment employed by the aforementioned IBM TPM product, workflows may include “Jython” which enable Java [TM] plug-in interfaces to be utilized in the solution. Jython is an open-source implementation of a well-known, object-oriented language Python, seamlessly integrated with the Java platform. It is complementary to Java because it is especially suited for embedded scripting, interactive experimentation, and rapid application development. Other workflow languages, however, may be used in the present invention.

Turning to FIG. 7, the diagram (70) depicts an example logical operation, a Firewall operation (71), being associated or implemented with a logical device (75), a Cisco [TM] system. In this example, a firewall logical device consists of four Access Control List (“ACL”) logical operations that include AddACL, DisableACL, EnableACL, and RemoveACL. When creating an automation workflow for a new type of firewall, an administrator can write a workflow to implement any of these logical operations as needed.

For example, when a new Cisco [TM] firewall is needed in a data center, its logical operations (71) such as Create ACL (72), Disable ACL (73), and Device Initialize (74) are used. Corresponding workflows Create ACL (76), Disable ACL (77), and Device Initialize (78) are written to implement these logical operations specific to the Cisco system.

Determination of Common Denominator Configuration

According to one available embodiment, the present invention is realized in cooperation with or in extension to a provisioning management which provides server pool sharing. Server pool showing allows for partial solutions to be shared across multiple solutions in an optimal manner.

In order to resolve redundant workflows and steps across solutions, one available embodiment of the invention first determines the common componentry across the range of targeted solutions. For example, it may be determined that 65% of the components are the same in five different solutions or server configurations. Next, provisioning steps to realize the common components are defined into a workflow, which when executed, would realize a partial solution having those common components. This partial componentry can then be shared between the five solutions as potential backup systems, for which final “morphing” (e.g. executing a finalization workflow) is applied to realize a specific solution.

As such, the system determines the greatest amount of common componentry across several configurations of productions servers. For example, three server types in an enterprise, Server 1, Server 2, and Server N, such as the examples shown in FIG. 4 (41, 42, and 43). In this example, all three servers including a computing platform and operating system, and for the sake of this example, we will assume they are all three using the same hardware platform and operating system. However, in practice, hardware platform details (e.g. processor type, amount of RAM, disk space, disk speed, communications bandwidth, etc.) and operating system (e.g. operating system make and model including revision level and service update level) are factors in determining the highest common denominator.

This enterprise (40), then consists of these three server types (41, 42, 43), all of which include the same hardware platform, operating system, and a Lightweight Directory Access Protocol (“LDAP”) server program. As such, the highest common denominator for all three servers is this combination of components.

Therefore, according to the present invention, a workflow to configure this pseudo-clone which is best suited to serve as a near-backup system for any of these three systems, e.g. a “low priority” pseudo-clone (49′″), would be defined to include only these components. This enables that when using a pseudo-clone according to this pre-configuration (49′″), only the following completion provisioning steps (400) would be necessary in case of a failure of a specific targeted server:
(a) if Server 1 fails, the pseudo-clone system would be provisioned (400) with:
   1. a WebSphere Application Server license;
   2. a DB2 Universal Database license; and
   3. a Netview license;
(b) if Server 2 fails, the pseudo-clone system would be provisioned (400) with:
   1. a WebSphere Application Server license;
   2. an Oracle 9i Database license; and
   3. a Netview license; or,
(c) if Server N fails, the pseudo-clone system would be placed (400) directly into service as it already contains all of the necessary components to replace the functionality of Server N.

So, further according to the present invention, three completion workflows can be defined for quickly realizing a replacement for each of the three servers using the steps outlined—Server 1 using steps (a)(1-3), Server 2 using steps (b)(1-3), or Server N by simply redirecting traffic data from Server N to the pseudo-clone.

In each of these scenarios, completion or final provisioning (400) steps are reduced such that the following steps do not have to be performed following the failure event:
(1) configuring the hardware platform;
(2) installing an operating system, upgrades, and service packs;
(3) and installing a LDAP server program.

By “pre-configuring” this pseudo-clone (49″) using a workflow to already have the highest common denominator componentry of all three servers, it allows “finish out” configuration (400) using a workflow to a specific server configuration in minimal steps, minimal time, and minimal risk upon a failure event of any of the three servers (41, 42, 43).

However, if the targeted resource pool is reduced to just Servers 1 and 2 (41, 42), then the highest common denominator would be determined to be the hardware platform and operating system, a LDAP server, plus a Netview license and a WebSphere Application Server suite. As such, a workflow to configuration a “high priority” pseudo-clone (49′) for a pool of servers 1 and 2 (41, 42), but not Server N, is defined. When this pseudo-clone is configured (48) using this particular workflow, finally provisioning (400) using a completion workflow to take on the configuration and tasks of either Server 1 or Server 2 in a fail-over or disaster recovery situation is even quicker to perform. So, using this higher-level of pseudo-clone (49′) pre-configuration targeting just Servers 1 and 2, only the following completion or “finish out” provisioning steps (400) would be included in the completion workflows as follows:
(a) if Server 1 fails, the pseudo-clone system would be provisioned with a DB2 Universal Database license; or
(b) if Server 2 fails, the pseudo-clone system would be provisioned with an Oracle 9i Database license.

In each of these scenarios, provisioning time and risk is reduced such that the following steps (48) do not have to be performed following the failure event:
(1) configuring the hardware platform;
(2) installing an operating system, upgrades, and service packs;
(3) installing a LDAP server program;
(4) installing a WebSphere Application Server; and
(5) installing a Netview program.

By “pre-configuring” (48) this higher-level pseudo-clone using a workflow to already have the highest common denominator componentry of all a small variety of servers (e.g. just Servers 1 and 2 but not N), it allows even quicker “finish out” configuration to a specific server configuration in minimal steps, minimal time, and minimal risk upon a failure event of any of the targeted servers (41, 42). However, if Server N fails, reconfiguring the pseudo-clone to perform the functions of Server N may enabled and assisted using a workflow as well, such as de-provisioning certain components.

Of course, other levels of pre-configured servers (49″) are possible, depending on the number of configuration options and configurations deployed in the production environment.

For example, in FIG. 4, if we assign the variables to the server components as follows:
A=operating system “XYZ”, revision level XX
B=computing platform “LMNOP”
C=LDAP Server program or license
D=WebSphere Application Server program or license
E=Oracle 9i database application program or license
F=DB2 Universal database application program or license
G=Netview application program or license

then, the configurations of each server expressed in Boolean terms wherein “*” means logical “AND”, and “+” means logical “OR”:
SVR(1)=A*B*C*D*F*G;
SVR(2)=A*B*C*D*E*G; and
SVR(N)=A*B*C

In this representation, the first level pseudo-clone suitable for being a rapid replacement for all three servers 1, 2 and N would have the highest common denominator configuration of:
PS-CLONE(1+2+N)=A*B*C

Another pseudo-clone which is a higher level clone of just Servers 1 and 2, but not for Server N, would have the configuration of:
PS-CLONE(1+2)=A*B*C*D*G

As such, workflows may be denoted in similar manner such as WF_{PS(1+2+N)} for a workflow to realize a pseudo-clone configuration of PS-CLONE(1+2+N), etc.

The example of FIG. 4 is relatively simple, with just three different server configurations, and seven different component options. As such, it may be misleading to assume that the highest common denominator can be determined almost visually for such systems, while in practice, the number of configuration options or characteristics which must be considered in order to determine highest-common denominator pseudo-clone pre-configurations is much greater and more complex, including but not limited to the following options:
(1) hardware platform, including memory amount, disk size and speed, communications bandwidth and type, and any application-specific hardware (e.g. video processors, audio processors, etc.);
(2) operating system make and model (e.g. IBM AIX [TM], Microsoft Windows XP Professional [TM], Unix, Linux, etc.), including any applicable revision level, update level, and service packs;
(3) application programs and suites, including but not limited to web servers, web resource handlers (e.g. streaming video servers, Macromedia FLASH servers, encryption servers, credit card processing clients, etc.), database programs, and any application specific programs (e.g. programs, Java Beans, servlets, etc.), including revision level of each; and
(4) any middle-ware or drivers as required for each application.

For these reasons, the present invention can employ relatively simple logic for simple applications and enterprise configurations, or may employ ontological processes based on axiomatic set theory, such as processes employing Euclid's Algorithm, Extended Euclid's Algorithm, or a variant of a Ferguson-Forcade algorithm, is employed to find the highest or greatest common denominator which each server configuration is viewed as a set of components. It is within the skill of those in the art to employ other logical processes to find common sets and subsets of a given sets, as well.

Use of Server Logs to Predict Configuration Requirements

Server logs (45) are preferably collected (53) from the various servers for use in determining which components are likely to fail, and the expected time to failure. Hardware and even software components have failure rates, mean-time-between-failures, etc., which can be factored into the analysis to not only determine which pseudo-clone pre-configurations will support which subsets of production servers, but which production servers will likely fail earliest, so that more pseudo-clones for those higher failure rate production servers can be pre-configured and ready in time for the failure.

According to a further enhanced embodiment of the present invention, the expected time to failure and expected failure rates are applied to the pseudo-clone configurations to determine times in the future at which each pseudo-clone should actually be built and made ready.

As in the previous examples using FIG. 4, PS-CLONE(1+2+N) reliability predictions using of expected time to first failure E_{FF} for each component can be calculated as:

E_{FF-PS(1+2+N)}=Earliest of (E_{FF-A}+E_{FF-B}+E_{FF-C}+E_{FF-D}+E_{FF-E}+E_{FF-G})

where E_{FF-X} is the individual expected time to first failure for component X.

At the earliest expected time of failure E_{FF-PS(1+2+N)} of any of the components of the PS-CLONE(1+2+N), the pseudo-clone system could be configured and made ready in the Pseudo-clone pool. Otherwise, until this time, the resources which would be consumed by the pseudo-clone can be used for other purposes.

Also note that unlike the determination of a highest common denominator for the pre-configuration of a pseudo-clone, the logical process of evaluation of the earliest time to first failure of a group of servers have different components must include all (e.g. the maximum superset) of the components that are in any of the targeted servers, not just the common components or the pseudo-clone components. This is because the pseudo-clone may be needed at a time which a component in a targeted server fails even when the component is a component which will be configured into the pseudo-clone in the completion steps (400).

Turning to FIG. 5, a high-level representation of how pseudo-clone systems are established is shown, including some of the optional or enhanced aspects as previously described. Based on the data from server logs (53), an initial server activity and history is established (51) for each production server to be cloned. The invention optionally continues to monitor (53) for any server or requirement changes (52) based on server logs and new requirement information. If there are no changes (54), monitoring continues. If changes occur, or upon initial pseudo-clone pre-configuration, the invention reviews all information collected from sources such as the provisioning manager files (55) and other historical metric data (56).

A prediction is made (57) regarding each system component's factors such as need, priority level, and available resources. Next, the largest common denominator componentry is calculated (58), and appropriate pre-configuration and finish configuration workflows are determined (59).

These workflows for the pre-configuration and finish configuration (30) for the pseudo-clone(s) (500) are output to the provisioning management system (30) for scheduling of implementation of the pseudo-clone.

Optionally, the activity for the targeted servers is tracked (53) and statistics (56) are updated in order to improve predictions and expectations, and thus pseudo-clone availability, over time as real events occur.

Integration of Pseudo-Clone Logic to Provisioning Manager Systems using Workflows

Using extensions to the provisioning management system, backup clients are integrated with each server using a failover workflow definition. This creates a failover pool with standby servers designated which creates an pseudo-clone for each server, where each pseudo-clone is suitable for a plurality of targeted production servers.

Failover workflow provisioning process are used when a failover event occurs which provides administrators with more management capability while decreasing manual steps required previously. The failed server is then decommissioned in the production pool and returned to a maintenance mode for further repair or recovery. IT administrators have the ability to configure backups frequently when necessary and monitor each solutions by using the orchestration defined monitoring workflows. Therefore, backups from production servers are stored in backup (or pseudo-clone) server pools.

According to one aspect of a one available embodiment of the invention, the ability to automate uninstallion or reinstallation of applications based on the role of each provisioned server is employed, with a combination in imaging technologies, disk partitioning, boot control, and automation logic that drives application and backup which enables the automation capability.

Resource Priority Module and Common Componentry Workflow

Because the nature of provisioning these complex systems requires such meticulous attention in its steps, a problem often arises in defining the proper intersection for sharing among multiple solutions. Therefore, a highest common denominator of componentry across all targeted solutions is preferably determined and implemented as a pseudo-clone. This allows for the largest number of workflow provisioning steps to be performed in advance, and a minimal number of workflow steps to be performed to morph the partial, common solution into a specific solution when it is needed.

According to one available embodiment of the present invention, a Resource Priority Module (“RPM”) and Common Componentry Workflow (“CCW”) module are provided embodying the logical processes of the invention. Turning to FIG. 8, overall system (80) using the RPM (80) module and the CCW module (85) achieves workload balancing for the creation of shared server pools. Resource pools (51) of currently used and available servers (Server A, Server B, Server N) and applications (Application Server A, Application Server B, Application Server N) are tracked and monitored by an inventory log (82). When new solutions requirements are determined or received from a customer, RPM assesses the business requirements by reviewing existing resources and work load from the inventory log.

Next, RPM conducts an analysis to translate the business requirements into technical specifications. This allows the new requirements to be determined and identify priorities associated with each specification.

The CCW (85) receives the ranked requests and reviews to determine workflow redundancy to perform logical operations. Based on findings, CCW creates one or more workflows (88) implementing a common denominator of componentry which will yield pseudo-clone(s) (87) when executed by the provisioning management system. CCW also determines and produces one or more completion workflows (89) which, when executed by the provisioning management system, modify a pseudo-clone to yield a specific solution for placing in server in the production environment (81).

Virtualization of Workflows and Re-use of Workflow Templates

Similar to the virtualization of componentry from specific components to Logical Device Operations as discussed relative to FIG. 6, the present invention implements virtualization of the workflows themselves. In virtualization of workflows, sections of workflows or workflow “templates” are saved into a library of workflows. Templates can be identified as “common components” of workflows using CCW, or may be manually identified by administrators and provisioning experts. This provides an inventory of building blocks which are later made available to workflow developers and administrators, especially during times in which development of a workflow quickly is required.

Turning to FIG. 9, a logical process (90) according to the invention is shown, in which a workflow to build a new server is to be developed by an administrator or workflow designer. The process typically starts (91) by receiving requirements (84) for the system to be realized, followed by defining a master workflow (92) for the new system. The new system may be a replacement server, or may be a server to meet a previously-unmet requirement set.

A set of workflow templates (97) is then searched (93), and the common componentry of other known servers is analyzed (85), to identify workflow templates which already exist that could be employed in the new master workflow for the new system. These templates could have been previously developed as workflow components, or extracted from complete workflows due to identification by CCW that they represent commonly used portions of workflows.

For example, the steps required to provision a particular “bare metal” computing platform A with an operating system B and with data communications protocol C may be used often as an early phase of provisioning, wherein subsequent provisioning steps may yield the differentiation needed for specific solutions. As such, the workflow steps for obtaining system A, installing OS B, and installing protocol C can be identified as a workflow template, named and saved (97) for later re-use. When a workflow designer desires to create a new system workflow which includes system A, OS B, and protocol C, the invention will find (93) the applicable template, and suggest (94) its reuse to the designer.

After all available workflow templates have been identified and proposed (94) to the designer, the design may finalize the workflow design and allow CCW to analyze the new workflow (95) to find any extractable templates for archiving (93) and later re-use by other workflow designers.

The final workflow, which was “virtualized” by nature of building it using as many workflow templates as possible, is then output (96) for use in actually realizing a computing system according to the steps set forth in the workflow.

This ability to dynamically create subsystem workflow templates that can be re-used by administrators to quickly and rapidly provision and deploy applications greatly improves the ability to recover quickly from failures, re-use unused or under-utilized assets, and to meet contractual quality of service requirements.

Once these common pieces of workflow have been identified and archived, their availability is made known to future to system workflow designers, such as the example as described with respect to FIG. 7. Through this level of virtualization of workflow development, coupled with virtualization of the logical devices being employed by new solutions, workflow designers are able to quickly define systems with new requirements (e.g. new solutions) or meeting previous requirements (e.g. replacement servers). This promotes a new workflow design paradigm: instead of designing from outside in (e.g. getting a user's requirements followed by performing internal design), the process is reversed to designing from the inside out (e.g. first, analyze the available components for inside the solution, followed by suggesting and re-using building blocks to build a workflow).

Multi-level Pool Sharing and Searching by Workflow Analysis

In another aspect of the present invention, when a workflow to implement a new or replacement system is to be developed, existing workflows and templates are search on a multi-level basis, preferably searching for a closest existing match first, and descending in a tree-like analysis to least-close matches, until a match is found, if available. This allows existing solutions to be identified, and then a subsequent search can be made to see if any actual configured systems and be re-purposed for the new application (or replacement application).

Consider a hypothetical situation where a data center is running a variety of servers for a variety of customers, wherein the servers are pooled by customers. For example, a first pool of servers may be allocated to a hypothetical catalog retail client MegaStore, a second pool of servers may be allocated to a hypothetical online merchant “eShops”, and a third pool of servers may be allocated internal enterprise operations for spare parts shipments for an automobile manufacturer “Smith Motor Works”. Further assume that the platforms used by MegaStore have a 85% common componentry with eShops, and that the workflows to realize the servers for each customer are also 85% in common. Also assume, for the sake of this example, that the servers for eShops only have a 40% common componentry and workflow with MegaStore's allocated servers.

Using the invention, as workflows were originally developed for each of these customer's solutions, their common workflow templates were also identified, stored, and made available. Now, some time in the future, when a new system is to be added to MegaStore's server pool, or when a replacement server is needed in MegaStore's server pool, a workflow to implement the new system is developed. At the onset, MegaStore's available resources in their allocated pool can be checked to see if enough hardware and software licenses are available to implement the new system.

If not, however, the virtualized workflow can be used to search for a closest available match, such as the eShop server, which has high level of commonality (e.g. 85%) with the workflow (and implementation) of the MegaStore solutions. Next, the available resources in eStore's pool can be checked, and if sufficient resources are available, they can be reallocated from eStore to MegaStore, and workflow to re-provision or re-purpose the reallocated assets to realize the new system for MegaStore is produced and executed.

If, though, sufficient resources are not available in the highest matching pool, then a next lower level match can be found, such as Smith Auto Work's server pool. If sufficient available assets are found their, the reallocation and implementation workflow can be made to realize the new server for MegaStore.

Turning to FIG. 10, the multi-level matching approach is shown in which the process of searching for known templates and partial solutions (93) uses CCW to search (1075) for highest level match between the required workflow and known workflows and workflow templates. If none is found at the highest level (1076), then searching continues in a tree-like fashion for lower-level matches (1077), until a highest-available match is found and retrieved (1078) for possible use in the new workflow.

In an alternate embodiment of the invention, a “lowest common denominator” “LCD”) configuration can also be used to enable High Availability (e.g. systems which are expected to run without re-booting for 24 hours per day, 7 days per week, 365 days per year). This would represent a much lower-level match of workflows, but would allow the workflow template to find a high degree of re-use in future workflows.

Enhanced Embodiments and Applications of the Invention

There are a number of aspects of enhanced and optional embodiments of the present invention, including a number of business processes enabled by certain aspects of the present invention.

System Upgrade and Patch Installation. According to one aspect of an option in an available embodiment, the invention can be used during system upgrades or patch installation with a controlled failover. In such a scenario, an administrator would plan when a production server would be upgraded or patched, and would implement the pseudo-clone before that activity starts. Then, to cause a graceful transition of the targeted system out of service, the administrator could initiate a simulated failure of the targeted system, which would lead to the provisioning management system placing the pseudo-clone online in place of the targeted system.

Infected and Quarantined Systems. According to another aspect of the present invention, a system which is diagnosed as being infected with a virus or other malicious code can also be quarantined, which effectively appears to be a system failure to the provisioning management system and which would lead to the pseudo-clone system being finally configured and place online.

Sub-Licensed Systems. According to yet another aspect of an enhanced embodiment of the invention, pseudo-clones may be created, including the workflows to realize those pseudo-clones, with particular attention to sub-licensing configuration requirements. In this embodiment, not only is the entire pseudo-clone server configured in a certain manner to match a highest common component denominator of a group of targeted servers, but the common denominator analysis (58) is performed at a sub-server level according to any sub-licensing limitations of any of the targeted servers. For example, if one of three targeted servers is sub-licensed to only allow a database application to run on 3 of 4 processors in one of the servers, but all other target servers require the database application running on all available processors, the highest common denominator of all the targeted servers would be a sub-license for 3 processors of the database application, and thus the pseudo-clone would be partially configured (48) to only include a 3-processor database license. If the pseudo-clone were later to be completion provisioned (400) to replace on of the fully-licensed servers, the license on the pseudo-clone would be upgraded accordingly as a set of the completion provisioning.

Super-Licensed Systems. In a variation of the sub-licensing aspect of the present invention, license restrictions may be considered when creating a pseudo-clone which targets one or more servers which are under a group-level license restriction. Instead of sub-licensing, this could be considered “super-licensing”, wherein a group of servers are restricted as to how many copies of a component can be executing simultaneously. In such a situation, the pseudo-clone configuration workflow can optionally either omit super-licensed components from the pseudo-clone configuration, or mark the super-licensed components for special consideration for de-provisioning just prior to placing the finalized replacement server online during completion provisioning.

In the first optional process, the invention determines (58) if a component of a highest common denominator component set is subject to a super-license restriction on any of the targeted servers. If so, it is not included in the pseudo-clone workflow for creating (48) the pseudo-clone, and thus the super-licensed component is left for installation or configuration during completion provisioning (400) when the terms of the super-license can be verified just before placing the replacement server online.

In the second optional process, the same super-licensing analysis is performed (400) as in the first optional process, but the super-licensed component is configured (48) into the pseudo-clone (instead of being omitted). The super-licensed component, however, is marked as a super-licensed component for later consideration during completion provisioning. During completion provisioning (400), the workflow is defined to check the terms of the super-license and the real-time status of usage of the licensed component, and if the license terms have been met or exceeded by the remaining online servers, the completion workflow de-provisions the super-licensed component prior to placing the replacement server online.

High Availability Prediction. According to another aspect of an enhanced embodiment of the present invention, the failure predictor (57) is not only applied to the components of the targeted computing systems, but is also applied (501) to the components of the pseudo-clone itself. By analyzing the failure rates of the pseudo-clone itself as defined by the largest common denominator (58) configuration, a workflow for realizing the pseudo-clone and the completion provisioning can be defined (59) which produces (60) to a standby server which will not likely fail while it is being relied upon as a standby server (e.g. the standby server will have an expected time to failure equal to or greater than that of the servers which it protects).

Grouping of Servers by High Availability Characteristics. Certain platforms are suitable for “high availability” operation, such as operation 24 hours per day, 7 days per week, 365 days per year. For example, these platforms typically run operating systems such as IBM's z/OS which is specifically designed for long term operation without rebooting or restarting the operating system. Other, low-availability platforms may run other operating system which do not manage their resources as carefully, and do not perform long term maintenance activities automatically, and as such, they are either run for portions of days, weeks, or years between reboots or restarts.

According to another optional enhanced aspect of the present invention, the failure predictor (57) is configured to perform failure prediction analysis on each server in the group of targeted servers, and to characterize them by their availability level such that the largest common denominator for a pseudo-clone can be determined to meet the availability objective of the sub-groups of targeted servers. Many times, this would occur somewhat automatically with the invention, as availability level of servers is often linked to the operating system of a server, and operating systems are typically a “must have” component in a server which must be configured, even in a pseudo-clone. For example, consider a targeted group of five servers in which 3 servers are high-availability running IBM's z/OS, and 2 servers are medium-availability running another less reliable operating system. The highest common denominator would not include an operating system, and thus a non-operational pseudo-clone would be configured without an operating system, therefore requiring grouping of the 5 servers into two groups along operating system lines.

But, in other configurations of servers, such critical components may be in common, but other non-critical components may determine whether the platform would be high, medium, or low availability. In these situations, this enhanced embodiment of the invention would be useful.

Time-to-Recover Objective Support. One of the requirements specified in many service level agreements between a computing platform provider/operator and a customer is a time objective for recovery from failures (e.g. minimum down time or maximum time to repair, etc.). In such a business scenario, it is desirable to predict the time that will be required to finalize the configuration of a pseudo-clone and place it in service. According to another aspect of an optional embodiment of the invention, the logical process of the invention analyzes the workflows and time estimates for each step (e.g. installation steps, configuration steps, start up times, etc.), and determines if the pseudo-clone can be completion provisioned for each targeted server within specified time-to-implement or time-to-recover times (502, 503). If not, the administrator is notified (504) to that a highest common denominator (e.g. closest available pseudo-clone) cannot be built which can be finalized within the required amount of recovery time. In response, the administrator may either negotiate a change in requirements with the customer, or redefine the groups of targeted servers to have a higher degree of commonality in each group, thereby minimizing completion provisioning time.

Time estimates for each provisioning step may be used, or actual measured time values for each step as collected during prior actual system configuration activities may be employed in this analysis. Alternatively, “firedrills” practices may be performed to collect actual configuration times during which a pseudo-clone is configured in advance, a failure of a targeted system is simulated, and a replacement system is completion provisioned from the pseudo-clone as if it were going to be placed in service. During the firedrill, each configuration step can be measured for how long is required to complete the step, and then these times can be used in subsequent analysis of expected time-to-recover characteristics of each pseudo-clone and each completion workflow.

Cluster Templates. According to another aspect of the present invention, not only are the workflows virtualized into reusable workflow templates, but the same technique is applied to the actual configurations of clustered servers, as well, to yield “cluster templates”. How different clusters have been configured (e.g., what software products need to be installed on servers in the cluster, their network configuration, storage configuration etc.) is also analyzed by CCW to find common denominator partial cluster configurations, and these are stored as cluster templates for later retrieval and reuse during further configuration and provisioning activities Preferably, a cluster template includes, or is associated with, workflow information required to implement that portion of a cluster configuration.

### CONCLUSION

Several example embodiments and optional aspects of embodiments have been described and illustrated in order to promote the understanding of the present invention. It will be recognized by those skilled in the art that these examples do not represent the scope or extent of the present invention, and that certain alternate embodiment details may be made without departing from the spirit of the invention. Therefore, the scope of the present invention should be determined by the following claims.

What is claimed is:

1. A method for designing workflows for a provisioning management system comprising the steps of:
evaluating workflows used to realize a group of targeted computing systems to determine a common denominator of workflow steps among said group of targeted computing systems;
producing a pseudo-clone workflow including said common denominator set of workflow steps which is executable by a provisioning management system to yield a pseudo-clone system; and
producing a plurality of completion workflows each of which correspond to a specific targeted computing system, and which is executable by a provisioning management system on a pseudo-clone to yield a replacement computing system for a targeted computing system.

2. The method as set forth in claim 1 wherein said step of determining a common denominator of workflow steps comprises determining a highest common denominator of workflow steps.

3. The method as set forth in claim 1 wherein said step of determining a common denominator of workflow steps comprises determining a lowest common denominator of workflow steps.

4. The method as set forth in claim 1 further comprising the steps of:
identifying a set of workflow steps in a workflow under analysis which are in common with one or more pre-existing workflows;
archiving said set of common workflow steps as a workflow template; and
disposing said workflow template in a data store which is searchable by workflow designers and workflow design tools.

5. The method as set forth in claim 4 further comprising the steps of:
accessing and searching said archived workflow templates;
identifying available workflow templates which match at least a portion of a workflow under development;
indicating to a user said available matching workflow templates; and
incorporating one or more matching workflow templates upon user control into said workflow under development.

6. The method as set forth in claim 5 further comprising performing a multi-level search of said archived workflow templates and of pre-existing workflows, said search ranking each template or pre-existing workflow according to a level of match with one or more specified level criteria, and wherein said step of indicating to a user said available matching workflow templates further comprises
providing an indication of said ranking of each matching template or pre-existing workflow.

7. The method as set forth in claim 6 wherein said search proceeds according to a highest-to-lowest level match according to common workflow steps.

8. The method as set forth in claim 6 wherein said search proceeds according to a lowest-to-highest level match according to common workflow steps.

9. The method as set forth in claim 6 wherein said search proceeds according to a quickest-to-slowest level match according to expected time to execute a workflow incorporating each matching workflow template or pre-existing workflow.

10. The method as set forth in claim 1 further comprising the steps of:
determining one or more subsets of targeted computing systems having a higher degree of workflow step commonality than said highest common denominator set of workflow steps of all targeted computing systems in said group;
producing one or more higher-priority pseudo-clone workflows executable by a provisioning management system to yield one or more pseudo-clone configurations having a highest common denominator set of components for said subsets; and
producing a plurality of higher-priority completion workflows each of which correspond to a specific targeted computing system and are executable executed by a provisioning management system on a pseudo-clone to yield a replacement computing system for a targeted computing system.

11. The method as set forth in claim 1 wherein:
said step of evaluating workflows further comprises evaluation of server cluster configurations to determine a common denominator of server cluster configuration definitions; and
said step of producing a pseudo-clone workflow further comprises producing a common cluster configuration template including said common denominator of server cluster configuration definitions.

12. A computer readable medium encoded with software for designing workflows for a provisioning management system, said software when executed by a computer performing steps comprising:
evaluating workflows used to realize a group of targeted computing systems to determine a common denominator of workflow steps among said group of targeted computing systems;
producing a pseudo-clone workflow including said common denominator set of workflow steps which is executable by a provisioning management system to yield a pseudo-clone system; and
producing a plurality of completion workflows each of which correspond to a specific targeted computing system, and which is executable by a provisioning management system on a pseudo-clone to yield a replacement computing system for a targeted computing system.

13. An apparatus for designing workflows for use by a provisioning management system, said apparatus comprising:
a workflow analyzer adapted to evaluate workflows used to realize a group of targeted computing systems to determine a common denominator of workflow steps among said group of targeted computing systems;
a pseudo-clone workflow generator configured to produce a pseudo-clone workflow including said common denominator set of workflow steps which is executable by a provisioning management system to yield a pseudo-clone system; and
a completion workflow generator configured to produce a plurality of completion workflows each of which correspond to a specific targeted computing system, and which is executable by a provisioning management system on a pseudo-clone to yield a replacement computing system for a targeted computing system.
